(19) United States
(12) Patent Application Publication
(10) Pub. No.: US 2014/0235170 A1
(43) Pub. Date: Aug. 21, 2014

(54) METHODS AND SYSTEMS FOR CONNECTING MULTIPLE DEVICES ONLINE

(71) Applicant: TENCENT TECHNOLOGY (SHENZHEN) COMPANY LIMITED, Shenzhen (CN)

(72) Inventors: BOQUAN ZHANG, Shenzhen (CN); YINGSHUO ZHANG, Shenzhen (CN); WEI JIN, Shenzhen (CN); LINJIE ZHU, Shenzhen (CN)

(73) Assignee: TENCENT TECHNOLOGY (SHENZHEN) COMPANY LIMITED, Shenzhen (CN)

(21) Appl. No.: 14/187,491

(22) Filed: Feb. 24, 2014

Related U.S. Application Data
(63) Continuation of application No. PCT/CN2013/087194, filed on Nov. 15, 2013.

(30) Foreign Application Priority Data
Feb. 21, 2013 (CN) 201310055728.X

(51) Int. Cl. H04W 76/02; H04W 4/00

(52) U.S. Cl. CPC H04W 76/02; H04W 4/008
USPC 455/41.2

(57) ABSTRACT

A method and system for establishing network connections among multiple devices are disclosed. The method includes the steps of a server establishing a network using Bluetooth and Wi-Fi technologies, and a first client initiating a Bluetooth connection or a Wi-Fi connection. The method further includes the steps of connecting the first client to the server and the first client exchanging data with an application hosted on the server. The method and system consistent with the present disclosure may improve the user experience for online computer games.

### CROSS-REFERENCES TO RELATED APPLICATIONS

### Related Applications

This application is a continuation application of PCT Patent Application No. PCT/CN2013/087194, filed on Nov. 15, 2013, which is based upon and claims the benefit of priority from Chinese Patent Application No. 201310055728.X, filed on Feb. 21, 2013, the entire contents of all of which are incorporated herein by reference.

### FIELD OF THE INVENTION

The present invention relates to network technologies and, more particularly, to methods and systems for connecting multiple devices online.

### BACKGROUND

With the rise of iOS devices, iOS games have gained popularity. iOS games with multiple players are especially entertaining for the players. However, connecting multiple devices online may be difficult for some users. In particular, entry-level users may not understand wireless technologies. Such users often cannot correctly use wireless technologies, such as Wi-Fi or Bluetooth, to properly connect devices online.

In addition, iOS devices often use a single mode connection, such as a Wi-Fi connection mode or a Bluetooth connection mode, Certain iOS devices, such as iPads, may have unstable links when using the connection to establish a Local Area Network (LAN). When the Wi-Fi connection is unstable, these devices cannot make proper online connections. In addition, when there are multiple or complex Wi-Fi networks in the same area, iOS devices may switch networks by mistake. For example, two iOS devices using Wi-Fi connections may be on the same network, if one iOS device mistakenly switched to a different network, the two iOS devices would not be on the same router. As a result the two iOS devices may not be able to communicate to each other.

The disclosed method and system are directed to solve one or more problems set forth above and other problems.

### BRIEF SUMMARY OF THE DISCLOSURE

Embodiments consistent with the present disclosure provide a method, system, client device, or a server for making network connections. Embodiments consistent with the present disclosure further improve the quality of the network connections for the connecting devices.

One aspect of the present disclosure provides a method for making network connections among multiple devices. The method includes a server establishing a network using Bluetooth and Wi-Fi technologies and a first client initiating a Bluetooth connection or a Wi-Fi connection. The method further includes connecting the first client to the server and the first client exchanging data with an application hosted on the server.

Another aspect of the present disclosure provides another method for making network connections among multiple devices. The method includes a server establishing networks using wireless technologies including Bluetooth and Wi-Fi technologies and a first client initiating a Bluetooth connection. The method further includes a second client initiating a Wi-Fi connection, connecting the first client and the second client to the server, and the first and second clients exchanging data with an application hosted by the server.

Another aspect of the present disclosure provides a system for connecting devices online. The system comprises a server configured to initiate and maintain a network using Bluetooth and Wi-Fi technologies and a first client configured to initiate a Bluetooth connection or a Wi-Fi connection. Further, the first client connects to the server using either a Bluetooth connection or a Wi-Fi connection. The first client exchanges data with an application hosted by the server.

Another aspect of the present disclosure provides another system for connecting multiple devices. The system includes a server configured to initiate a plurality of networks using wireless technologies including Bluetooth and Wi-Fi technologies; a first client configured to establish a Bluetooth connection; and a second client configured to establish a Wi-Fi connection. Further, the first client and the second client connect to the server. The first and second clients exchange data with an application hosted on the server.

In the embodiments consistent with the present disclosure, because the server may maintain both Bluetooth and Wi-Fi networks, when making a connection, the client may not need to select the network connection type. The embodiments consistent with the present disclosure thus would make it easier for users to connect client devices online and address issues related to unstable Wi-Fi connections. In addition, the embodiments consistent with the present disclosure may enable clients to make multi-mode connections (e.g., using Wi-Fi and Bluetooth connections) and therefore provide stable online device interconnections and improve user experience.

Other aspects of the present disclosure can be understood by those skilled in the art in light of the description, the claims, and the drawings of the present disclosure.

### BRIEF DESCRIPTION OF THE DRAWINGS

To illustrate embodiments of the invention, the following are a few drawings illustrating embodiments consistent with the present disclosure.

FIG. 1 is a flowchart of an exemplary network connection method used by embodiments consistent with the present disclosure;

FIG. 2 is a block diagram of an exemplary online computer game embodiment consistent with the present disclosure;

FIGS. 3a-3f are diagrams of exemplary user interfaces used by the exemplary online computer game embodiment consistent with the present disclosure;

FIG. 4 is another block diagram of an exemplary client used by embodiments consistent with the present disclosure;

FIG. 5 illustrates an exemplary operating environment incorporating certain disclosed embodiments; and

FIG. 6 illustrates a block diagram of an exemplary computer system consistent with the disclosed embodiments.

### DETAILED DESCRIPTION

Reference will now be made in detail to exemplary embodiments of the invention, which are illustrated in the accompanying drawings. Hereinafter, embodiments consistent with the disclosure will be described with reference to drawings. Wherever possible, the same reference numbers will be used throughout the drawings to refer to the same or like parts. It is apparent that the described embodiments are some but not all of the embodiments of the present invention. Based on the disclosed embodiment, persons of ordinary skill in the art may derive other embodiments consistent with the present disclosure, all of which are within the scope of the present invention.

In embodiments consistent with the present disclosure, a server may refer to any computing device that can establish and host one or more networks. A server may establish and maintain multiple networks, such as both Bluetooth and Wi-Fi networks. Single-mode connections may refer to network connections using only one type of technology, such as using Wi-Fi or Bluetooth. Multi-mode connections may refer to network connections using multiple types of technologies. A server using multi-mode connections allows devices to connect to it using any of the supported technologies, such as both Wi-Fi and Bluetooth technologies.

A client consistent with the present disclosure may be any computing device that can make network connections. A client may be a mobile client, i.e., a mobile computing device. A client may also be referred to as a client device. A client may establish a Bluetooth or a Wi-Fi network. A client may use the Bluetooth and/or Wi-Fi technologies to connect with the server. After a client connects to a server, it may exchange data with the server.

In the embodiments consistent with the present disclosure, because the server may maintain both Bluetooth and Wi-Fi networks, when making a connection, the client may not need to select the network connection type. The embodiments consistent with the present disclosure thus would make it easier for users to connect client devices online and address issues related to unstable Wi-Fi connections. In addition, the embodiments consistent with the present disclosure may enable clients to make multi-mode connections (e.g., using Wi-Fi and Bluetooth connections) and therefore provide stable online device interconnections and improve user experience.

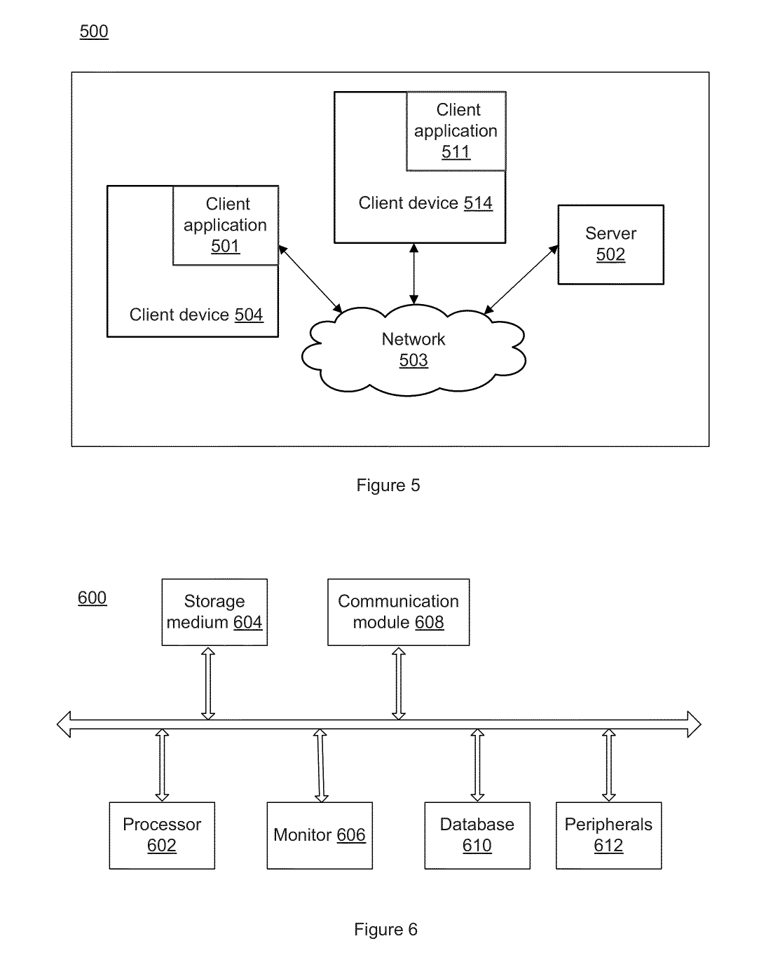

FIG. 5 illustrates an exemplary online computer game environment 500 incorporating certain disclosed embodiments. As shown in FIG. 5, environment 500 may include client devices 504 and 514, a network 503, and a server 502. The network 503 may include any appropriate type of communication network for providing network connections to the client devices 504 and 514, and the server 502. For example, network 503 may include the Internet, LAN, or other types of computer networks or telecommunication networks, either wired or wireless.

A server, as used herein, may refer to one or more server computers configured to provide certain functionalities, which may require any user accessing the services to authenticate to the server before the access. A server may also include one or more processors to execute computer programs in parallel. The server 502 may include any appropriate server computers configured to provide certain server functionalities, such as establishing and hosting networks using both Wi-Fi and Bluetooth technologies. After the server establishes networks with Wi-Fi and Bluetooth, it may wait for client devices, such as client devices 504 and 514, to join its networks. Although only one server is shown, any number of servers can be included. The server 502 may operate in a cloud or non-cloud computing environment.

Client devices 504 and 514 may include any appropriate type of mobile computing devices, such as iOS devices, or devices using any other computing platforms. Client devices 504 and 514 may include one or more client applications 501 and 511. The client applications 501 and 511, as used herein, may include any appropriate software application, hardware application, or a combination thereof to achieve certain client functionalities. For example, client 501 may be an iOS online computer game application. Any number of client applications 501 may be included in the environment 500.

In one embodiment, the client device 504 may connect to a server 502 using both a Bluetooth and a Wi-Fi connection. The network may use the Wi-Fi network as the default network for clients to connect to the server 502. When the client device 504 cannot establish a Wi-Fi connection or detects a faulty Wi-Fi connection, then the client would connect to the server using a Bluetooth connection.

Further, when there is more than one client on the network, the network may be a network allowing multi-mode connections. For example, a first client device 504 may connect to the server 502 using a Wi-Fi connection; and a second client device 514 may connect to the server 502 using a Bluetooth connection. The client devices 504 and 514 may join one or more applications hosted by the server 502, and exchange data with the server 502. In other embodiments, a network allowing multi-mode connections may include a plurality of networks. For example, a first client device 504 may connect to the server 502 through a Wi-Fi network; and a second client device 514 may connect to the server 502 using a Bluetooth network.

Further, when there is more than one client on the network, the network may be a network allowing multi-mode connections. For example, a first client may connect to the server using a Wi-Fi connection; and a second client may connect to the server using a Bluetooth connection. In other embodiments, a network allowing multi-mode connections may include a plurality of networks, each using a different technology (single-mode connections). For example, a first client device may connect to the server through a first Wi-Fi network; and a second client device may connect to the server using a second Bluetooth network. In other embodiments, a network allowing multi-mode connections may include a combination of one or more networks allowing multi-mode connections and one or more networks, each using a different technology.

Client devices 504/514 and server 502 may be implemented on any appropriate computing platform. FIG. 6 illustrates a block diagram of an exemplary computer system 600 capable of implementing client devices 504/514 and server 502.

As shown in FIG. 6, computer system 600 may include a processor 602, a storage medium 604, a monitor 606, a communication module 608, a database 610, and peripherals 612. Certain devices may be omitted and other devices may be included.

Processor 602 may include any appropriate processor or processors. Further, processor 602 can include multiple cores for multi-thread or parallel processing. Storage medium 604 may include memory modules, such as Read-only memory (ROM), Random Access Memory (RAM), flash memory modules, and erasable and rewritable memory, and mass storages, such as CD-ROM, U-disk, and hard disk, etc. Storage medium 604 may store computer programs for implementing various processes, when executed by processor 602.

Further, peripherals 612 may include I/O devices such as keyboard and mouse, and communication module 608 may include network devices for establishing connections through the communication network. Database 610 may include one or more databases for storing certain data and for performing certain operations on the stored data, such as database searching.

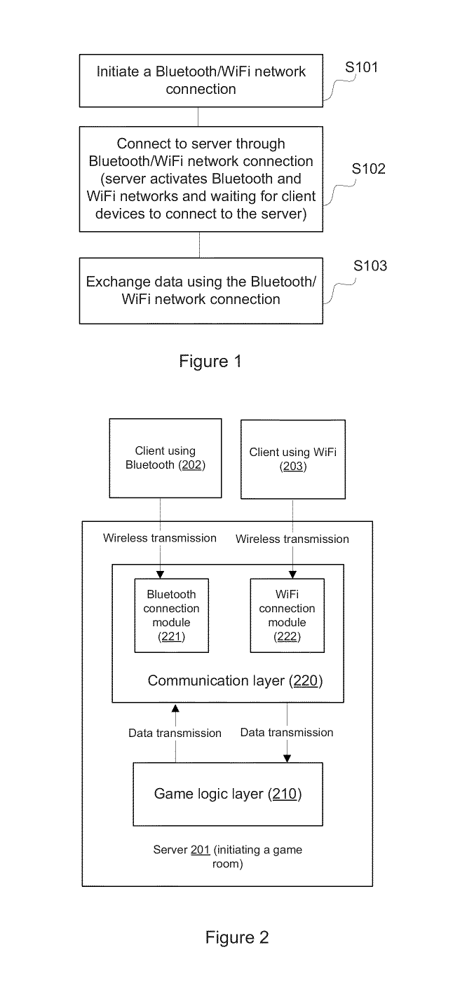

In operation, client devices/client applications 501/504 or server 502 may establish single-mode or multi-mode network connections to play an online multi-player game. FIG. 1 shows a flow chart of a network connection method implemented by embodiments consistent with the present disclosure. The method may comprise steps S101-S103.

In step S101, a client, such as an iOS device, may initiate a Bluetooth or a Wi-Fi connection. In step S102, the client may use the Bluetooth or the Wi-Fi connection to connect with a server. The server may maintain a Bluetooth and a Wi-Fi network. The server may also start one or more applications, such as an online computer game application, waiting for the client to connect to its networks.

In the embodiments consistent with the present disclosure, the server may be any device that can control one or more of software applications. For example, the server may be a computing device that can initiate an online game room. The client may be any client device that can connect to the server, which includes any device that can connect to server to play an online computer game.

When a Wi-Fi or Bluetooth connection to a network is unstable, the single-mode online connections using only Wi-Fi or Bluetooth technology may have problems such that the client devices cannot properly connect to the network. To solve these problems, embodiments consistent with the present disclosure may initiate and maintain multiple networks on the server. For example, the server may initiate and maintain both a Bluetooth network and a Wi-Fi network. The server may also initiate an online computer game application or other applications, waiting for a client to join its networks to perform online operations.

Embodiments consistent with the present disclosure may include one or more clients. A client may initiate a Bluetooth or a Wi-Fi connection, or both a Bluetooth and a Wi-Fi connection. As such, a client may connect to the server by using the Bluetooth and/or Wi-Fi connections.

In one embodiment, a client may connect to a server using both a Bluetooth and a Wi-Fi connection. The network may designate the Wi-Fi network as the default network for the client to connect to the server. When the system cannot establish a Wi-Fi connection or detect a faulty Wi-Fi connection, then the client could connect to the server using a Bluetooth connection.

Further, when there is more than one client on the network, the network may be a network allowing multi-mode connections. For example, a first client may connect to the server network using a Wi-Fi connection; and a second client may connect to the server network using a Bluetooth connection. In other embodiments, a network allowing multi-mode connections may include a plurality of networks, each using a different technology (single-mode connections). For example, a first client device may connect to the server through a first Wi-Fi network; and a second client device may connect to the server using a second Bluetooth network. In other embodiments, a network allowing multi-mode connections may include a combination of one or more networks allowing multi-mode connections and one or more networks allowing single-mode connections.

In step S103, after connecting to the sever, the client may exchange data with the server through the one or more applications hosted on the server. Using the connection to the server, the client may join one or more applications hosted on the server. The client may then further exchange data with the server.

In embodiments with multiple clients, e.g., two clients, the data exchange may be carried out as follows. A first client may connect to the server using a Wi-Fi connection. A second client may connect to the server using a Bluetooth connection. The first and second clients may use their corresponding connections to exchange data with the server. The first client and second clients may also exchange data with each other through the server.

FIG. 2 shows a schematic of an exemplary online computer game system consistent with the present disclosure. In FIG. 2, the online computer game system includes a server 201 that initiates an online game room. The online computer game system further includes two clients 202 and 203 that use different connection modes to connect to the server. The first client 202 connects to the server 201 using a Bluetooth connection. The second client 203 connects to the server 201 using a Wi-Fi connection. The software on the server may have a communication layer 220 and a game logic layer 210. Each layer may implement specific functions so that the server 201 may support multiple networks and/or multi-mode network connections.

The communication layer 220 may receive data from clients 202 and 203. The communication layer 220 may also include a Bluetooth connection module 221 and a Wi-Fi connection module 222 with each module handling the corresponding network connection. The communication layer 220 may transfer data received through the Bluetooth connection module 221 and the Wi-Fi connection module 222 to the server 201 or other devices.

The game logic layer 210 may handle function related to games. For example, in a game named “Baby Drummer,” the server 201 may keep track of the players' scores. A player may use a client device, such as the client 202, to play the game. The server 201 may use the game logic layer 210 to manage game functions, such as the functions related to tracking the players' scores. The server 201 may also enable all players in the game room to view the scores of other players.

In the exemplary game “Baby Drummer,” the online battle mode may use the Bluetooth and Wi-Fi multi-mode networks. In this example, there may be three gaming devices: Device A, B, and C. Device A may be a hosting device. Device A may also be referred to as a server. Device B and Device C are client devices that may connect to the network. Device B and C may be referred to as the clients. In addition, Device B may connect to Device A using Wi-Fi. Device C may connect to Device A using Bluetooth. The “Baby Drummer” game may operate as follows.

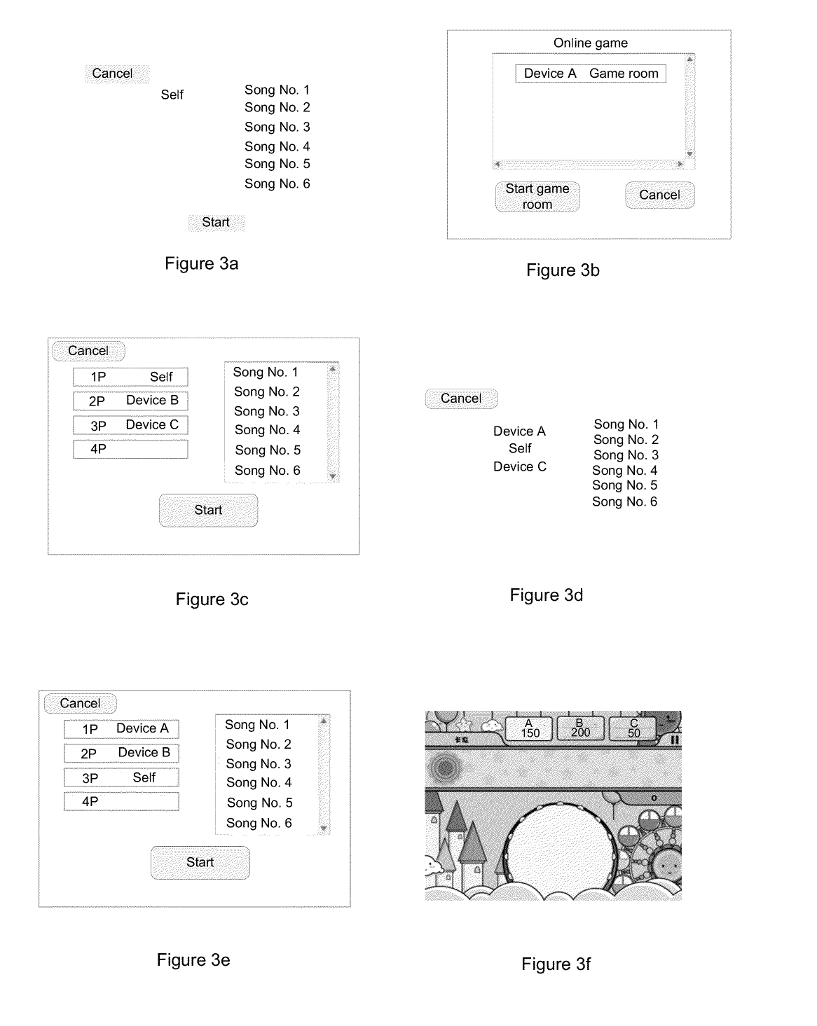

First, the hosting Device A may initiate Bluetooth and Wi-Fi networks, allowing devices to connect to the network using either a Wi-Fi or a Bluetooth connection. FIG. 3a shows a game room initiated by the hosting Device A. As shown in FIG. 3a, hosting Device A has opened a game room in the battle mode. Hosting Device A is displayed at the 1P position and is noted as “self” on the screen. Hosting Device A is waiting for other players to join the game.

In this example, Device B has initiated a Wi-Fi connection. Device B and Device A are on the same router. Device C has initiated a Bluetooth connection but not a Wi-Fi connection. Device C is not on the same router as hosting Device A. Device B and C can view the game room initiated by hosting Device A. FIG. 3b shows an interface that Device B and Device C may use to enter the game room initiated by hosting Device A. As shown in FIG. 3b, after clicking the button “Device A—Game room,” Device B and Device C can join the game room hosted by hosting device A.

FIG. 3c shows an exemplary interface on Device A. As shown in FIG. 3c, Device A is being placed at the 1P position in the game room; Device B is being placed at the 2P position in the game room; and Device C is being placed at the 3P position in the game room. FIG. 3d shows an exemplary display on Device B. Similarly, FIG. 3e shows an exemplary display on Device C. As shown in FIGS. 3c-3e, Device A, Device B, and Device C are being placed at the 1P, 2P, and 3P positions respectively in the game room.

Once Devices A, B, and C are connected, hosting Device A may start the game. Devices A, B, and C may play the drumming game as shown in FIG. 3f. As described above, in this embodiment, the client devices (B and C) do not need to select the network connection type when they join the game room. Hosting Device A hosts the game room, which enables multi-mode connections. In this example, Device B uses a Wi-Fi connection to connect with hosting Device A. Device C uses a Bluetooth connection to connect with hosting Device A. Hosting Device A can make connections with both Device B and Device C. Device B and Device C can exchange data through their connections with hosting Device A.

In the embodiments consistent with the present disclosure, after a hosting device initiates an online game room, the client devices do not need to select the type of network connection. Client devices may connect to the game room use various connections, such as a Wi-Fi or a Bluetooth connection. This makes it easier for clients to connect to other devices and play multi-player games.

In addition, the embodiments consistent with the present disclosure may enable clients to make multi-mode connections (e.g., using Wi-Fi and Bluetooth connections) and therefore provide stable online device interconnections and improve user experience. Further, embodiments consistent with the present disclosure may be implemented using iOS operating systems, Android based operating systems, and other operating systems.

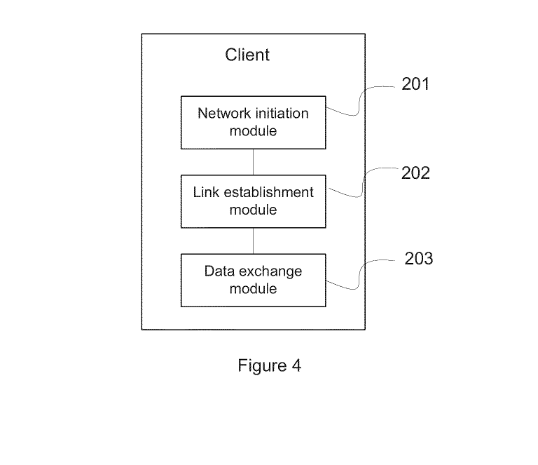

FIG. 4 shows an exemplary client device consistent with the present disclosure. The exemplary client device may include a network initiation module 201, a link establishment module 202, and a data exchange module 203. The client device may use the network initiation module 201 to initiate a Bluetooth or a Wi-Fi network connection. The client device may use the link establishment module 202 to establish a network connection with a server using Bluetooth or Wi-Fi. The server may initiate and maintain Bluetooth and Wi-Fi networks while waiting for client devices to join the network. The client device may further use the data exchange module 203 to exchange data through an application (e.g., an online computer game application) hosted by the server.

In the embodiments consistent with the present disclosure, a server may be any device that can control one or more of software applications, such as online computer games. For example, a server may be a computing device that can initiate an online game room. A client may be any client device that can connect to the server, which includes any device that can connect to server to play an online computer game.

When a Wi-Fi or Bluetooth connection is unstable, the single-mode online connections using only Wi-Fi or Bluetooth technology may have problems such that the client devices cannot connect to the network. To solve such problems, embodiments consistent with the present disclosure may initiate and maintain multiple networks on the server. For example, the server may initiate and maintain both a Bluetooth network and a Wi-Fi network. The server may also initiate an online computer game application or other applications, waiting for a client to join its networks to perform online operations.

Embodiments consistent with the present disclosure may include one or more clients. A client may initiate a Bluetooth or a Wi-Fi connection, or both a Bluetooth and a Wi-Fi connection. As such, a client may connect to the server by using the Bluetooth and/or Wi-Fi connections. In one embodiment, if a client can connect to a server using both a Bluetooth and a Wi-Fi connection. The network may use the Wi-Fi network as the default network for the client to connect to the server. When the system cannot establish a Wi-Fi connection or detects a faulty Wi-Fi connection, then the client could connect to the server using a Bluetooth connection.

Further, when there is more than one client on the network, the network may be a multi-mode network. For example, a first client may connect to the server using a Wi-Fi connection; and a second client may connect to the server using a Bluetooth connection. The clients may join one or more applications hosted by the server, and exchange data with the server.

In the example of the online computer game “Baby Drummer,” FIG. 2 shows the schematics of an exemplary online computer game system. In FIG. 2, the online computer game system includes a server 201 that initiates an online game room. The server 201 may be Device A as shown in FIGS. 3a-3f. The online computer game system further includes two clients 202 and 203 that use different connection mode to connect to the server. Clients 202 and 203 may be Device C and Device B as shown in FIGS. 3a-3f. The first client 202 connects to the server 201 using a Bluetooth connection. The second client 203 connects to the server 201 using a Wi-Fi connection. The software on the server 201 (Device A) may have a communication layer 220 and a game logic layer 210. Each layer may implements specific functions so that the server 201 (Device A) may support multiple networks or multi-mode connections.

In the exemplary game “Baby Drummer,” the online battle mode may use the Bluetooth and Wi-Fi multi-mode network. Device A may be the hosting device, Device B and Device C may connect to the network. Device B may connect to Device A using Wi-Fi. Device C may connect to Device A using Bluetooth.

In the embodiments consistent with the present disclosure, after a hosting device initiate an online game room, the connecting devices do not need to select the type of network connection. Connecting devices may connect to the game room use various supported connections, such as Wi-Fi or Bluetooth connections. This makes it easier for players to connect to other devices and play multi-player games.

Further, the embodiments consistent with the present disclosure may enable clients to make multi-mode connections (e.g., using Wi-Fi and Bluetooth connections) and therefore provide stable online device interconnections and improve user experience. Further, embodiments consistent with the present disclosure may be implemented using iOS operating systems, Android based operating systems, and other operating systems.

Consistent with embodiments of the present disclosure, one or more non-transitory storage medium storing a computer program are provided to implement the system and method for establishing network communications. The one or more non-transitory storage medium may be installed in a computer or provided separately from a computer. A computer may read the computer program from the storage medium and execute the program to perform the methods consistent with embodiments of the present disclosure. The storage medium may be a magnetic storage medium, such as hard disk, floppy disk, or other magnetic disks, a tape, or a cassette tape. The storage medium may also be an optical storage medium, such as optical disk (for example, CD or DVD). The storage medium may further be semiconductor storage medium, such as DRAM, SRAM, EPROM, EEPROM, flash memory, or memory stick.

Other embodiments of the disclosure will be apparent to those skilled in the art from consideration of the specification and practice of the invention disclosed herein. It is intended that the specification and examples be considered as exemplary only, with a true scope and spirit of the invention being indicated by the following claims.

### INDUSTRIAL APPLICABILITY AND ADVANTAGEOUS EFFECTS

Without limiting the scope of any claim and/or the specification, examples of industrial applicability and certain advantageous effects of the disclosed embodiments are listed for illustrative purposes. Various alternations, modifications, or equivalents to the technical solutions of the disclosed embodiments can be obvious to those skilled in the art and can be included in this disclosure.

By using the disclosed methods and systems, various network communication systems may be implemented. For example, a user may initiate an online collaboration session with multiple participants. The hosting device may establish networks using various network technologies, such as Wi-Fi, Bluetooth, etc. Each participant may connect to the hosting device using a supported network connection. For example, a first participant may connect to the host device using a Wi-Fi connection. A second participant may connect to the host device using a Bluetooth connection. The hosting device may then execute a software application to facilitate the online collaboration session.

What is claimed is:

1. A method for establishing network connections among multiple devices through a server, comprising:
establishing, by the server, a network using Bluetooth and Wi-Fi technologies;
initiating, by a first client, a Bluetooth connection or a Wi-Fi connection;
connecting the first client to the server; and
exchanging data with an application hosted on the server.

2. The method according to claim 1, further comprising:
establishing, by the first client, a Wi-Fi connection with the network; and
establishing, by the first client, a Bluetooth connection with the network when the Wi-Fi connection fails.

3. The method according to claim 2, the network having at least two clients connected to it, the method further comprising:
connecting, by the first client, to the application on the server by a Wi-Fi connection;
connecting, by a second client, to the application on the server by a Bluetooth connection;
exchanging data, by the first client, with the server;
exchanging data, by the second client, with the server; and
exchanging data between the first and second clients.

4. A method for establishing network connections among multiple devices, comprising:
initiating, by a first client, a Bluetooth connection;
initiating, by a second client, a Wi-Fi connection;
connecting the first client and the second client to a server wherein the server hosts networks using wireless technologies including Bluetooth and Wi-Fi technologies; and
exchanging data with an application hosted by the server.

5. The method according to claim 4, further comprising:
establishing, by the second client, a Wi-Fi connection with the network; and
establishing, by the second client, a Bluetooth connection with the network when the Wi-Fi connection fails.

6. The method according to claim 4, the network having at least two clients connected to it, the method further comprising:
connecting, by a first client, to the application on the server by a Wi-Fi connection;
connecting, by a second client, to the application on the server by a Bluetooth connection;
exchanging data, by the first client, with the server;
exchanging data, by the second client, with the server; and
exchanging data between the first and second clients.

7. A system for connecting devices online, comprising:
a server configured to initiate and maintain a network using Bluetooth and Wi-Fi technologies; and
a first client configured to initiate a Bluetooth connection or a Wi-Fi connection;
wherein the first client connects to the server using either a Bluetooth connection or a Wi-Fi connection, and the first client exchanges data with an application hosted on the server.

8. The system according to claim 7, wherein if the first client fails to connect to the server using the Wi-Fi connection, the first client then connects to the server using the Bluetooth connection.

9. The system according to claim 7, wherein the network has at least two clients connected to it, the system further comprising:
a second client configured to connect to the application on the server by a Bluetooth connection wherein the first client and the second client exchange data with the server.

10. The system according to claim 9, wherein the first client exchanges data with the second client.

11. A system for connecting multiple devices online, comprising:
a first client configured to establish a Bluetooth connection; and
a second client configured to establish a Wi-Fi connection;
wherein the first client and the second client connect to a server that is configured to initiate a plurality of networks using wireless technologies including Bluetooth and Wi-Fi technologies and exchange data with an application hosted on the server.

12. The system according to claim 11, wherein the second client connects to the server through a Bluetooth connection when the Wi-Fi connection fails.

13. The system according to claim 11, wherein the first client exchanges data with the second client.

14. The system according to claim 11, wherein the first client comprises:
a network initiation module configured to initiate the Bluetooth connection;
a link establishment module configured to establish the Bluetooth connection with the server; and
a data exchange module configured to exchange data with the application hosted on the server.

15. The system according to claim 11, wherein the server comprises:
a communication layer receiving data from the first client and the second client; and
a game logic layer managing functions of the application hosted on the server.
